(19) United States
(12) Patent Application Publication
(10) Pub. No.: US 2001/0032244 A1
(43) Pub. Date: Oct. 18, 2001

(54) Internet based help system

(76) Inventor: Michael S. Neustel, Fargo, ND (US)

Correspondence Address: Michael S. Neustel, 2534 South University Drive, Suite No. 4, Fargo, ND, 58103, US

(21) Appl. No.: 09/741,446

(22) Filed: Dec. 19, 2000

Related U.S. Application Data
(60) Provisional application No. 60/165,498, filed on Nov. 15, 1999.

(51) Int. Cl. G06F 17/60; G06F 15/16

(52) U.S. Cl. 709/206; 705/9

(57) ABSTRACT

An Internet based help system for establishing substantially real-time help dialog over the Internet between a client who has a question about a subject and a selected expert knowledgeable in that subject. The inventive system includes a plurality of experts on various topics located anywhere in the world that are stored within an “expert list” on a server computer. When any of the experts within the expert list log onto the Internet, software on the expert's computer notifies the server computer via the Internet that the expert is on-line and available for real-time help sessions with clients thereby logging the expert into an “expert on-line list” (EOLL). When a client accesses a website and requires assistance on a question about the subject, the client selects a “real-time help button” on the screen to enter a real-time question into. A help screen is shown either within the website or within a separate dialog box that has a location for the client to enter and submit the question in a written format. The question information is transmitted from the client's computer to the server computer that selects an expert from the EOLL. The question information is then transmitted to the selected expert which is displayed in a separate dialog box on the expert's computer. The expert has the option of “passing” on the question or answering the question. If the expert passes on the question, the server computer determines another expert to send the question information to. If the expert accepts the question, they type in their answer which is then sent to the client's computer. If the client likes the expert's answer, the client can choose to enter into real-time discussions with the expert and thereafter possibly utilizing that expert's services possibly. If the client does not like the expert's answer, the client can request a different expert to answer the same question.

### CROSS-REFERENCE TO RELATED U.S. PATENT APPLICATION

This application is related to United States provisional patent application Ser. No. 60/165,498 filed Nov. 15, 1999 now abandoned. The 60/165,498 application is hereby incorporated by reference into this application.

### BACKGROUND OF THE INVENTION

1. Field of the Invention

The present invention relates generally to Internet based help systems and more specifically it relates to an Internet based help system for establishing substantially real-time help dialog over the Internet between a client who has a question about a subject and a selected expert knowledgeable in that subject.

The Internet is a system of communications protocols that presents information in documents that are capable of being linked to other documents. The documents are stored in a distributed manner across the Internet on the networked computers, and are accessed using programs known as browsers. The Internet is a system of protocols exchanged between a host computer running an application, known as a server, that delivers Web documents, and a user's computer, known as the client. The most fundamental of Internet protocols is called the Transmission Control Protocol/Internet Protocol (TCP/IP) which in effect provides a description of the document data being exchanged and a destination for that data.

The Internet has become extremely popular over the past five years through the utilization of improved communication systems and cheaper computers. The Internet is comprised of millions of web pages that have information about various topics and businesses. Many individuals search the Internet to locate information about a specific topic or a specific question they may have. The main appeal of the Internet is the wealth of information that is available to individuals almost instantaneously. However, a recent study showed that approximately 70% of Internet users found it very difficult to locate the information they required.

With the advancement of technology, individuals are now able to receive “real-time” information from the Internet including but not limited to audio and video. Another popular real-time system utilized upon the Internet are “chat rooms” which allow individuals to write to each other in real-time. Chat rooms are generally available over the Internet using the Internet Relay Chat (IRC) protocol. IRC uses the TCP/IP protocol in a client/server model. IRC client software is installed on the user side and integrated into the Web browser. Once client initiates a channel by connecting to an IRC enabled server, which may or may not be on the same host as the Web server, other clients may join the channel by typing a join IRC command. The IRC server mediates the channel, passing each message to all channel members or to particular channel members, as determined by the originator of the message.

Unfortunately, even with the millions of web pages currently locatable upon the Internet and the expert websites, it is extremely difficult for users to locate the specific information they require without significant and time-consuming searching. Often times an individual has a single question they require an answer for and they will unfortunately search many web sites in an attempt to locate the answer.

When the individual does locate an informative website it can be difficult and time consuming for that individual to locate the answer within the website. The individual will sometimes send an e-mail with their question directly to an e-mail address on the website requesting information about their question. Unfortunately, many individuals receive numerous e-mails everyday and do not retrieve or review their e-mails every hour of the day, thereby leaving the individual's e-mail to remain unanswered for a significant period of time. Sometimes the e-mail goes unanswered because the individual who received it deleted the e-mail or chose not to respond to the e-mail. This adds to the frustration upon the Internet.

One recent attempted solution to the problem of not being able to locate information upon the Internet are “expert websites” such as http://www.expertcentral.com. Expert websites are designed to connect consumers with questions with experts who can answer these questions.

The most common design of such websites generally comprises a form that the consumer fills out along with their question. The form information along with the question is then sent via e-mail to one of the many experts. Sometimes the questions are stored within a “question bin” for the expert to manually retrieve. When the expert gets the question, it is then up to that particular expert on the subject to respond to the consumer. If the expert does not respond to the question, then individual may wait hours or days for the answer. Sometimes the experts will not even answer the question causing significant frustration for the individual. Most individuals utilizing the Internet want a real-time answer to their questions without having to wait for an individual to respond.

Hence, there is a need for an Internet based system that allows an individual to communicate in real-time with an individual knowledgeable regarding the subject matter so as to eliminate the “waiting time” for the consumer to receive an answer to a question.

2. Description of Related Art

Real-time systems have been in use upon the Internet for years. Typically, Internet real-time systems are utilized to transfer audio and video from a server computer to a client computer. These systems have been in use and have been proven over years of testing.

Another real-time system utilized upon the Internet are entitled chat rooms where various individuals are allowed to enter a “room” to discuss various topics. If an individual in a chat room wants to write in real-time to a specific individual in that chat room, they may “invite” that individual into a private chat session between only the two of them. Another system utilized which is not based upon real-time events are the above-stated “expert websites” which connect individuals with experts in a particular subject.

While these real-time systems may be suitable for the particular purpose to which they address, they are not as suitable for establishing substantially real-time help dialog over the Internet between a client who has a question about a subject and a selected expert knowledgeable in that subject. More particularly, none of the above systems allow an individual to request an answer from a knowledgeable expert on a specific topic. Finally, there simply is no suitable system for efficiently connecting clients who require information about a particular topic with an expert within that topic without significant time delays.

In these respects, the Internet based help system according to the present invention substantially departs from the conventional concepts and designs of the prior art, and in so doing provides a system primarily developed for the purpose of establishing real-time help dialog over the Internet between a client who has a question about a subject and a selected expert knowledgeable in that subject.

### SUMMARY OF THE INVENTION

In view of the foregoing disadvantages inherent in the known types of real-time systems now present in the prior art, the present invention provides a new Internet based help system wherein the same can be utilized for establishing substantially real-time help dialog over the Internet between a client who has a question about a subject and a selected expert knowledgeable in that subject.

The general purpose of the present invention, which will be described subsequently in greater detail, is to provide a new Internet based help system that has many of the advantages of the real-time Internet systems mentioned heretofore and many novel features that result in a new Internet based help system which is not anticipated, rendered obvious, suggested, or even implied by any of the prior art real-time devices, either alone or in any combination thereof.

To attain this, the present invention generally includes a plurality of experts on a subject located anywhere in the world that are stored within an “expert list” on a server computer. When any of the experts within the expert list log onto the Internet, software on the expert's computer notifies the server computer via the Internet that the expert is on-line and available for real-time help sessions with clients thereby logging the expert into a “expert on-line list” (EOLL). When a client accesses a website and requires assistance on a question about the subject, the client selects a “real-time help button” on the screen to enter a real-time question into. A help screen is shown either within the website or within a separate dialog box that has a location for the client to enter and submit the question in a written format. The question information is transmitted from the client's computer to the server computer that selects an expert from the EOLL. The question information is then transmitted to the selected expert which is displayed in a separate dialog box on the expert's computer. The expert has the option of “passing” on the question or answering the question. If the expert passes on the question, the server computer determines another expert to send the question information to. If the expert accepts the question, they type in their answer which is then sent to the client's computer. If the client likes the expert's answer, the client can choose to enter into real-time discussions with the expert and thereafter possibly utilizing that expert's services possibly. If the client does not like the expert's answer, the client can request a different expert to answer the same question.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an Internet based help system that will overcome the shortcomings of the prior art devices.

Another object is to provide an Internet based help system that will allow a client to receive an answer to a question in substantially real-time.

An additional object is to provide an Internet based help system that efficiently utilizes a pool of experts from various locations that are currently “on-line” to answer questions for clients.

A further object is to provide an Internet based help system that increases the efficiency of a user utilizing the Internet.

Another object is to provide an Internet based help system that allows an expert to answer or pass upon a specific question.

A further object is to provide an Internet based help system that allows an expert to perform their normal duties and activities without significant interruptions.

Another object is to provide an Internet based help system that efficiently connects clients with experts in a particular topic or subject matter.

An additional object is to provide an Internet based help system that allows an expert to perform their normal job duties or other activities along with answering questions of potential clients in substantially real-time.

Another object is to provide an Internet based help system that reduces the time it takes for a client to receive an answer for a question they send to an expert on a particular subject.

An additional object is to provide an Internet based help system that sorts through the experts' responses to questions and determines whether to eliminate certain individuals as experts based upon certain criteria.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram showing the connection of the client computer and the server computer connected to the Internet.

FIG. 2 is a flowchart showing the initial operation of the present invention for determining whether an expert is currently on-line and whether a client has entered a question.

FIG. 3 is a flowchart continuing from FIG. 2 showing the interaction between a selected expert and the client.

FIG. 4 is a flowchart illustrating a system for determining which experts are refusing to answer a certain number of questions.

FIG. 5 is a flowchart illustrating a system for determining which experts are not refusing or answering questions presented to them.

FIG. 6 is a flowchart illustrating a system for determining which experts are providing adequate answers to clients.

FIG. 7 is a sample web page screen allowing a client to enter a question regarding a specific topic.

FIG. 8 is a sample dialog box shown on a selected expert's computer displaying the name of the client, the question submitted and providing a box to enter the answer.

FIG. 9 is a sample web page screen that is displayed upon the client's computer after the selected expert answers the question.

FIG. 10 is a sample dialog box shown on the selected expert's computer providing feedback regarding the expert's answer to the client's question.

### DESCRIPTION OF THE PREFERRED EMBODIMENT

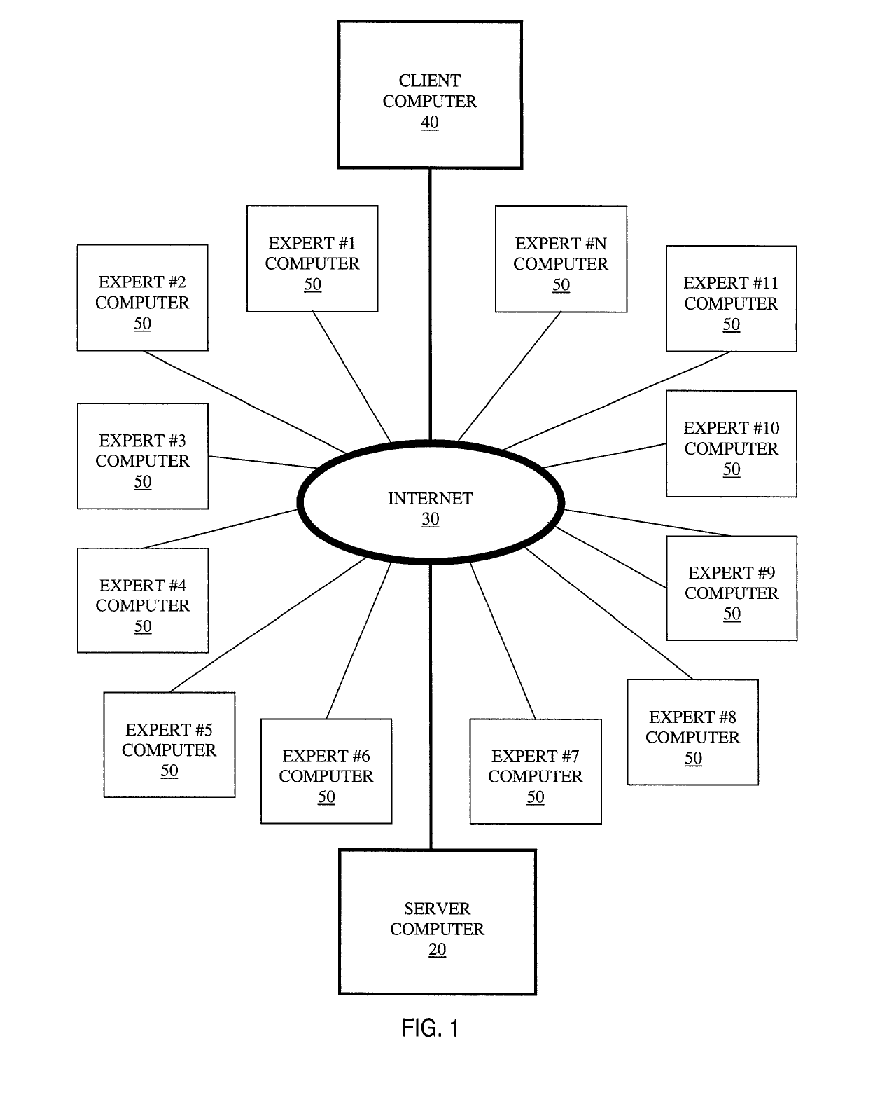

Turning now descriptively to the drawings, in which similar reference characters denote similar elements throughout the several views, FIGS. 1 through 10 illustrate an Internet based help system 10, which includes a plurality of experts on various topics located anywhere in the world that are stored within an “expert list” on a server computer 20. When any of the experts within the expert list log onto the Internet 30, software on the expert's computer 50 notifies the server computer 20 via the Internet 30 that the expert is on-line and available for help sessions with clients thereby logging the expert into an “expert on-line list” (EOLL). The present invention could utilize Local Area Networks (LAN) or WAN along with the Internet 30 to communicate with the expert computers 50. When a client accesses a website and requires assistance on a question about the topic, the client selects a “help button” or hyperlink on the screen to enter a question into. A help screen is shown either within the web page or within a separate dialog box upon the client computer 40 that has a location for the client to enter and submit the question in a written format. The question information is transmitted from the client's computer 40 to the server computer 20 that selects an expert from the EOLL. The question information is then transmitted to the selected expert which is displayed in a separate dialog box on the expert's computer 40. The expert has the option of “passing” on the question or answering the question. If the expert passes on the question, the server computer 20 determines another expert to send the question information to. If the expert accepts the question, they type in their answer which is then sent to the client's computer 40. If the client likes the expert's answer, the client can choose to enter into discussions with the expert and thereafter possibly utilizing that expert's services possibly. If the client does not like the expert's answer, the client can request a different expert to answer the same question or a different question.

The present invention may be utilized for various topics such as health, law, sports, family, dating, loans, and taxes and should not be limited by any discussions within. The number of topics available is virtually unlimited. The present invention provides a convenient system for connecting individuals with questions about a topic (“clients”) with knowledgeable individuals (“experts”) on a particular subject in a question/answer session.

### 1. Experts

As shown in FIG. 1 of the drawings, at least one expert is registered with the server computer 20 upon the “expert list”. Each expert has “help software” installed upon their computer 50 that communicates with the server computer 20 via the Internet 30 to notify the server computer 20 that the particular expert is “on-line”. The help software is designed to receive modifications from the expert based upon their schedules and activities as will be discussed later.

An expert is “on-line” when their computer 50 is currently connected to the Internet 30. The expert's computer 50 can be connected to the Internet 30 through various conventional systems such as direct dial-up telephone systems, DSL, ISDN, Ethernet LAN, radio signal, T1, T3 and various other systems. The expert's computer 50 is typically connected to the Internet 30 through a digital communications device such as a modem.

### 2. Clients

“Clients” are individuals browsing web pages on the Internet 30 and require an answer to a specific question they have. Clients typically “browse” web pages on the Internet 30 with “browsers” such as NETSCAPE or MICROSOFT EXPLORER. The browser allows the client's computer 40 to read and display html files from a website.

The client's computer 40, similar to the experts' computers 50, can be connected to the Internet 30 through various conventional systems such as direct dial-up telephone systems, DSL, ISDN, Ethernet LAN, radio signal, T1, T3 and various other systems. The client's computer 40 is typically connected to the Internet 30 through a digital communications device such as a modem.

### 3. Expert List

The “expert list” is a list of individuals that have either been recognized or purport to be knowledgeable within a specific topic or subject matter (“topic”). It can be realized that there may be many expert lists which are only limited by the number of topics available which are virtually limitless. An expert may participate in more than one expert list simultaneously or at various other times.

The expert list may be created by the system operator of the server computer 20 manually entering data information about each expert into the expert list which is stored upon the server computer 20 as shown in box 60. The expert list may also be created “automatically” by allowing purported experts to access a web page and enter the data information which is automatically recorded upon the expert list.

Data information about each expert on the expert list can include personal name, company name, address, e-mail, web sites, passwords, topics they are knowledgeable in, telephone numbers, fax numbers and any other useful information about each expert. Any individual who is listed as an expert upon the expert list may “logon” so as to be listed upon the “on-line list”.

### 4. Expert On-Line List (EOLL)

When an expert upon the expert list is “on-line” (“Internet session”), the expert is either automatically logged or manually logged onto the server computer 20 through the help software. When the expert's computer 50 sends the server computer 20 a “logon signal” through the Internet 30, the server computer 20 adds the expert to the EOLL as shown in block 64. The expert is now available for assisting clients with questions while they conduct their normal activities during the day or nighttime.

The expert can have the help software automatically notify the server computer 20 when they are on-line as shown in test block 62. However, many experts are busy individuals who cannot always be available to answer questions from clients when they are on-line. Hence, the expert can have the help software set so that the help software only notifies the server computer 20 when the expert manually selects a “logon feature” of the help software. The expert can also set the help software to automatically logon with the server computer 20 only during specific periods of time so as to not interrupt them during specific times during the day or specific days of the week. As can be appreciated, there are various other possible settings for the help software to accommodate various experts and their busy schedules which will not be discussed for obvious reasons.

When the expert terminates their Internet session, the help software upon the expert's computer 50 automatically sends a “logoff signal” to the server computer 20 as shown in test block 66. Upon receiving the logoff signal, the server computer 20 removes the expert from the on-line list since that particular expert cannot be accessed by a client in substantially real-time as shown in block 68. If an expert desires to maintain their Internet session, however they do not want to answer any questions from clients they may manually logoff by selecting a logoff feature of the help software as shown in test block 70 which takes them off the EOLL shown in block 72. If the expert desires to placed upon the EOLL again, they have to manually logon.

Another method of creating the EOLL would be for the server computer 20 to query each of the expert computers 50 listed upon the expert list to determine whether they are on-line. If the server computer 20 receives a positive response from a queried computer 50, that computer 50 is added to the EOLL. If the server computer 20 does not receive a response from a computer 50, that computer is removed from the EOLL. However, it is preferred to utilized the previous method for determining the EOLL because of the inherent flexibility provided for the experts.

### 5. Help Sessions

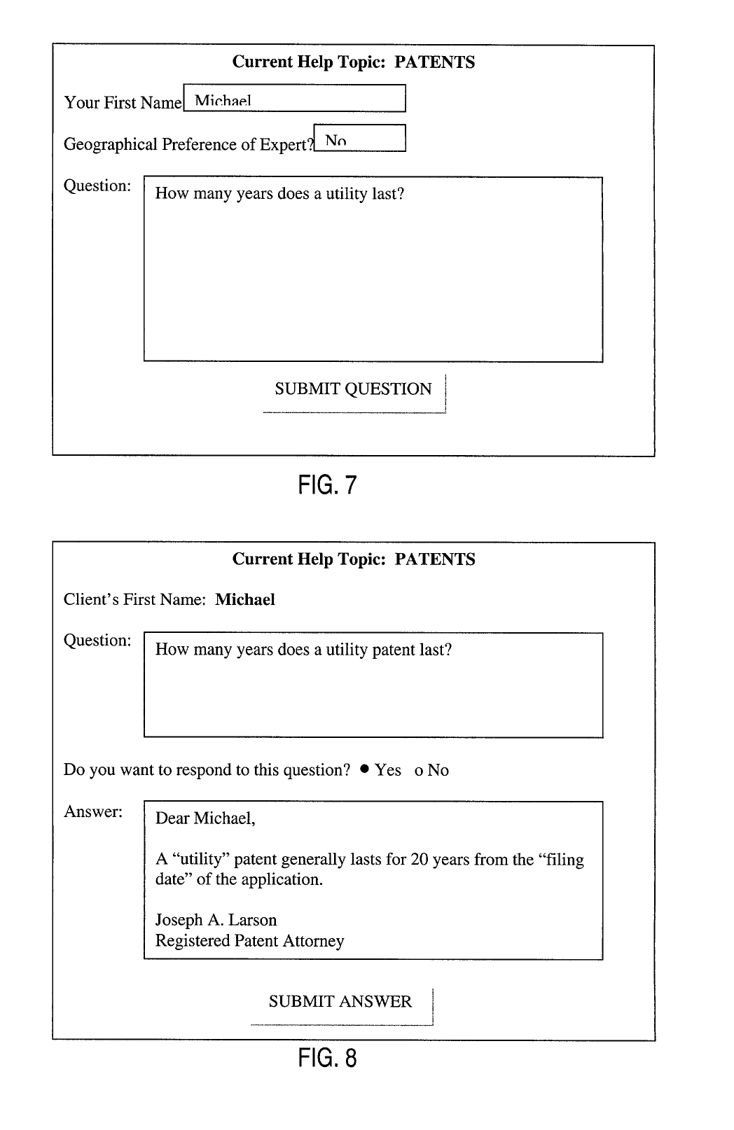

A “help session” occurs when a client types a question about a particular topic from their computer 40. A sample input screen is shown in FIG. 7 of the drawings. The client enters their name and other information into the input screen shown in FIG. 7 and represented in test block 100. After the client selects the SUBMIT QUESTION button the screen of their computer 40, the question is submitted to the server computer 20 via the Internet 30.

The server computer selects an expert from the EOLL and submits the question information along with information about the client to the selected expert as shown in boxes 120, 130. The selected expert's computer 50 displays information about the client, the question, an option to respond to the question, and a box to answer the question as shown in FIG. 8 of the drawings. If the expert selects “No” to responding to the question, another expert is selected by the server computer 20 to answer the question as shown in test block 140. If the expert does not state that they will respond to the question in “Time X”, the server computer 20 will automatically select another expert for the question. Time X can be any period of time, however it is preferably approximately 5-10 seconds to avoid significant delays to the client in receiving an answer.

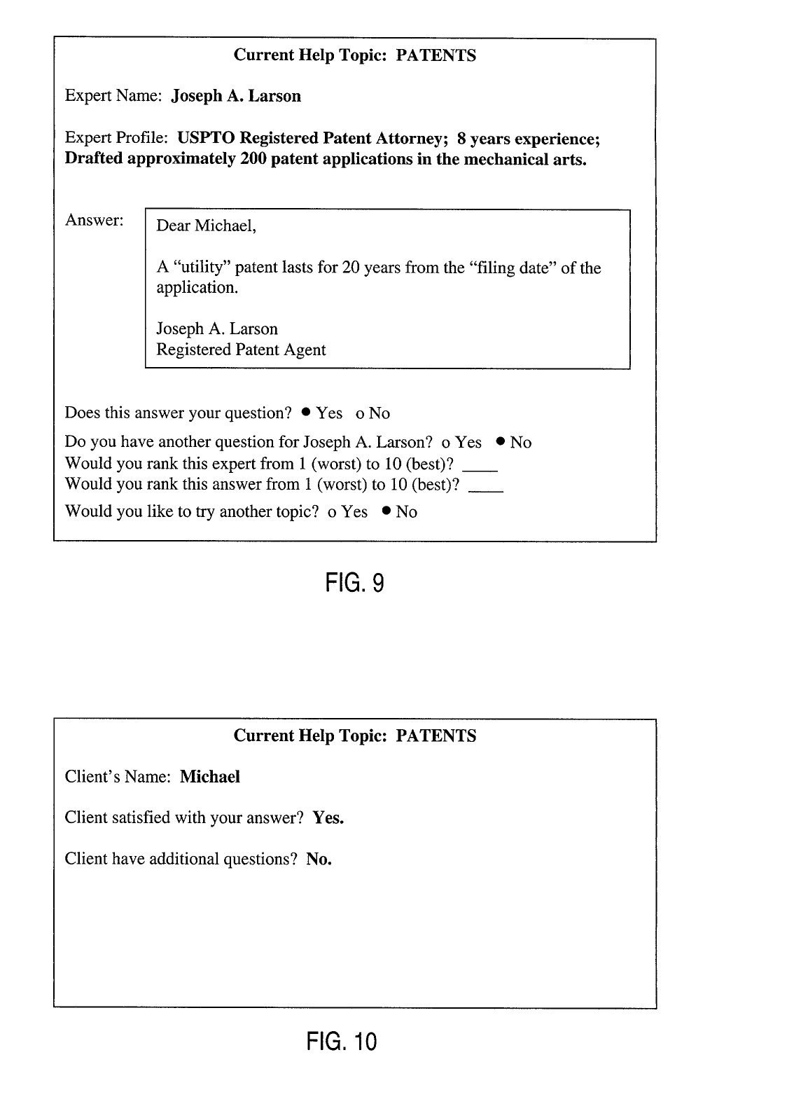

After the selected expert types in the answer to the question as shown in FIG. 8 of the drawings, the expert selects SUBMIT ANSWER upon the screen of their computer 50 which transmits the answer information to the server computer 20 which forwards the information in an html or other format to the client computer 40 where the answer is displayed. The answer is displayed preferably along with information about the expert who answered the question as shown in FIG. 9 of the drawings. If the client is satisfied with the question and has no more questions for the expert, a screen is displayed upon the expert computer 50 stating that the client was satisfied with the answer and had no further questions on that topic. If the client desires to ask another question of the expert, they can make a selection upon their screen which will provide another question screen for them to ask another question of the expert. As shown in test block 180, there is also the option for the client to request a different expert to answer the same question or a different question.

### 6. Monitoring Experts' Performance

a. Overview

As can be appreciated, the number of experts upon any topic list is virtually unlimited. Hence, monitoring the performance of each expert is virtually impossible to do without hiring a significant number of employees to monitor the answers of the experts.

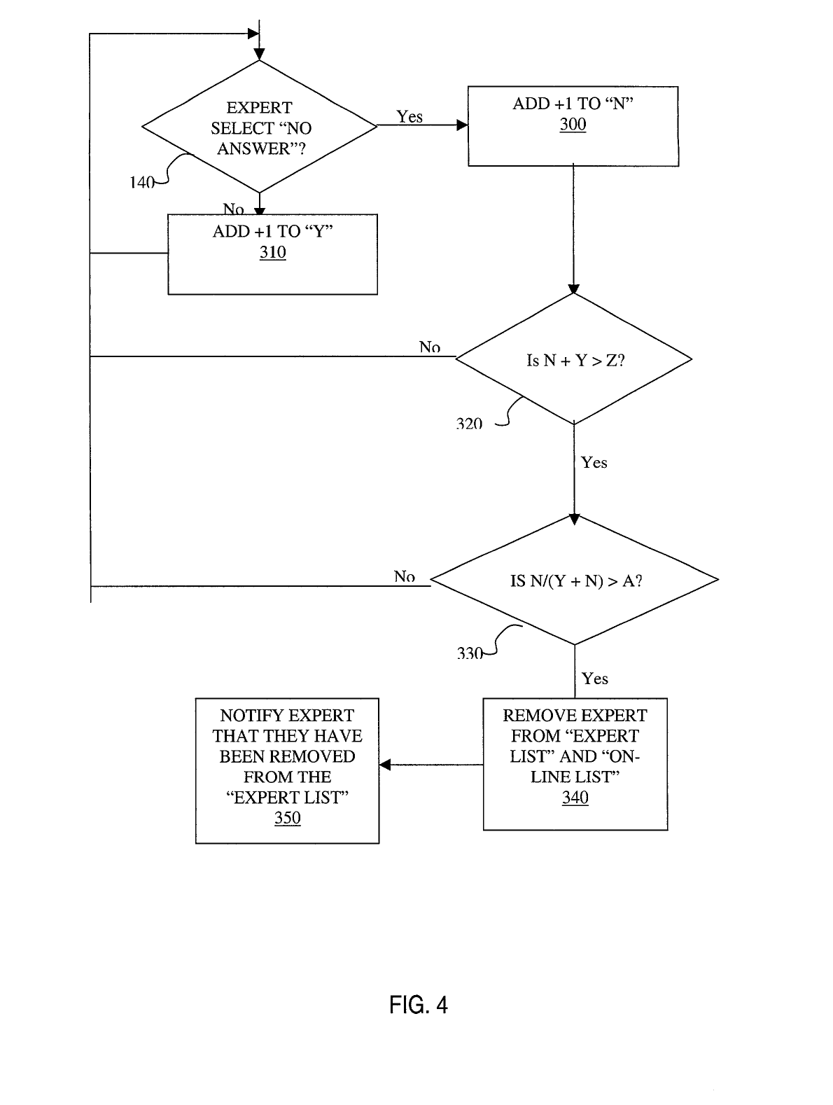

As shown in FIGS. 4, 5 and 6 of the drawings, the present invention includes a “monitoring system” for ensuring that every expert is providing adequate answers to clients. The monitoring system also ensures that no expert is “cherry picking” questions by allowing a significant number of questions to be passed upon. In addition, the monitoring system ensures that no expert is simply not responding to the dialog boxes that are displayed upon the screen of their computer 50.

b. Percentage of Questions Answered

As shown in test block 140 of FIG. 4, if an expert selects “No” to answering a question that they are selected for, the server computer 20 maintains a file for that expert recording the total number of times N that the expert has selected “No” to answering a question as shown in block 300. The server computer 20 also maintains a record of the total number of times Y that the expert has selected “Yes” to answering questions as shown in block 310 of FIG. 4.

To encourage each expert to attempt to answer questions, even the difficult questions, each expert must answer at least a specified percentage A of the questions as shown in test block 330. The percentage A of questions that the expert will have to answer to maintain their position upon the expert list is variable depending upon the topic and other factors.

For example, if A=0.20, if the expert does not answer 80% or more of the questions they are selected for, they are removed from both the expert list and the on-line list as shown in boxes 340, 350. However, the percentage of answers to questions does not begin until the expert has received greater than Z number of questions as shown in test block 320 of FIG. 4. The expert is notified that they have been removed from the expert list and they may only be added again through administration.

c. Percentage of Questions Accepted and Rejected Immediately

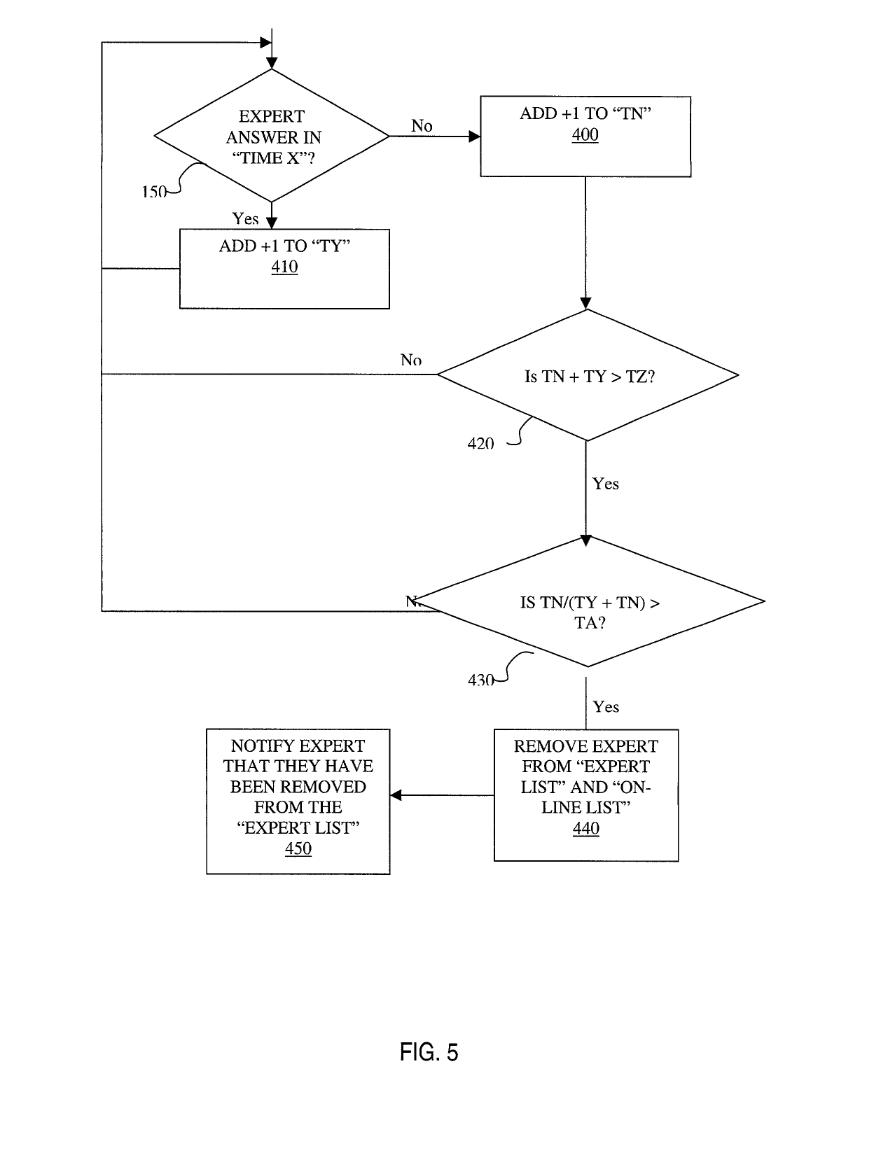

As shown in test block 150 of FIG. 5, if an expert does not accept or reject a question in time X, the server computer 20 maintains a file for that expert recording the total number of times TN that the expert has neglected to choose whether to answer the question or not as shown in block 400. The server computer 20 also maintains a record of the total number of times TY that the expert has selected to either answer or not answer the questions presented to them as shown in block 410 of FIG. 5. Time period X is preferably a shorter period of time such as 5 to 20 seconds to allow the server computer 20 to immediately locate another expert for the client's question.

To encourage each expert to immediately respond as to whether or not they are going to answer the question so that the client is ensured to receive an expedited response, each expert must accept or reject at least a specified percentage TA of the questions as shown in test block 430. The percentage (1.00−TA) of questions that the expert will have to either accept or reject to maintain their position upon the expert list is variable depending upon the topic and other factors.

For example, if TA=0.10, if the expert does not accept or reject 90% or more of the questions they are selected for, they are removed from both the expert list and the on-line list as shown in boxes 440, 450. However, the percentage of accepts/rejects to questions does not begin until the expert has received greater than TZ number of questions as shown in test block 420 of FIG. 5. The expert is notified that they have been removed from the expert list and they may only be added again through administration.

d. Percentage of Answers Acceptable to Clients

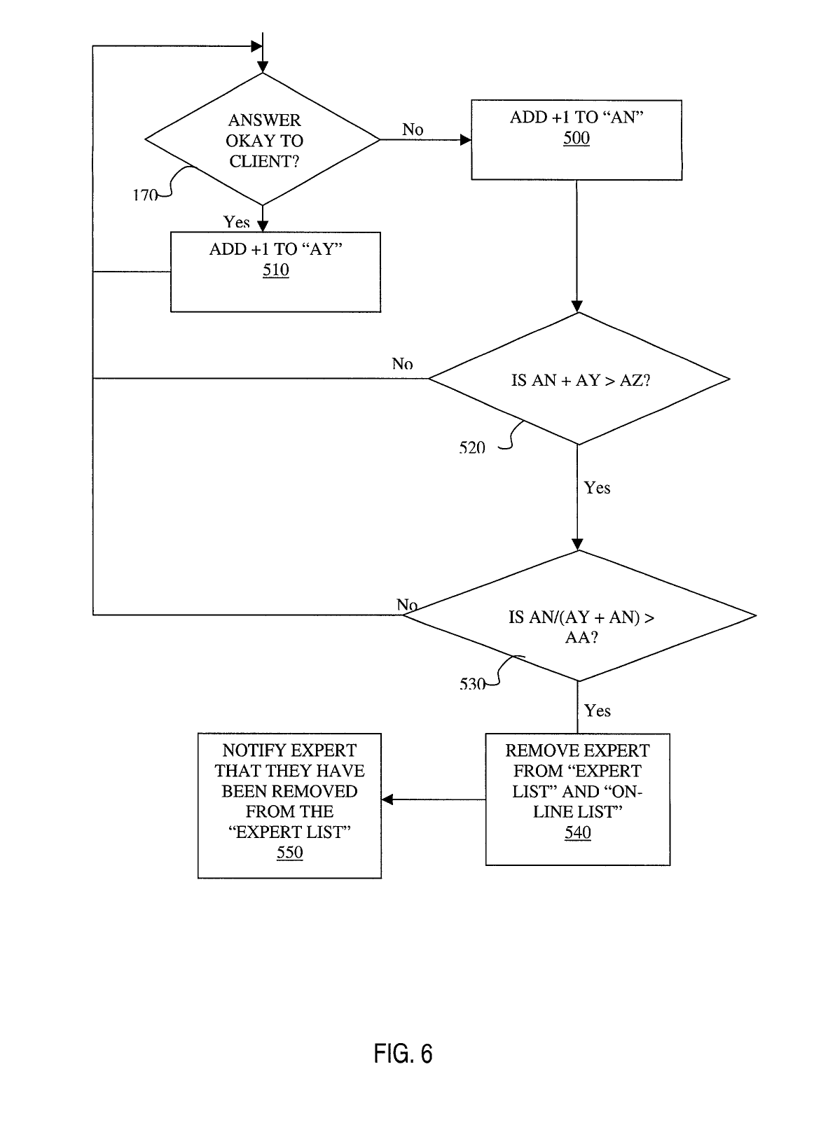

As shown in test block 170 of FIG. 6, if a client selects that an answer from the expert is not acceptable, the server computer 20 maintains a file for that expert recording the total number of times AN that a client of the expert has selected “No” to the acceptability of the question as shown in block 500. The server computer 20 also maintains a record of the total number of times AY that clients of the expert have selected “Yes” to the acceptability of the expert's answers as shown in block 510 of FIG. 5.

To encourage each expert to attempt to answer all of the questions in an adequate and thorough manner, even the difficult questions, each expert must satisfy at least a certain percentage of clients as shown in test block 530. The percentage (1.00−AA) of questions that the expert will have to answer to maintain their position upon the expert list is variable depending upon the topic and other factors.

For example, if AA=0.10, if the expert does not answer 90% or more of the questions they are selected for in a “acceptable” manner for the clients, they are removed from both the expert list and the on-line list as shown in boxes 540, 550. However, the percentage of answers to questions does not begin until the expert has received greater than AZ number of questions as shown in test block 520 of FIG. 6. The expert is notified that they have been removed from the expert list and they may only be added again through administration.

### 7. Operation of Invention

a. Creating the Expert List

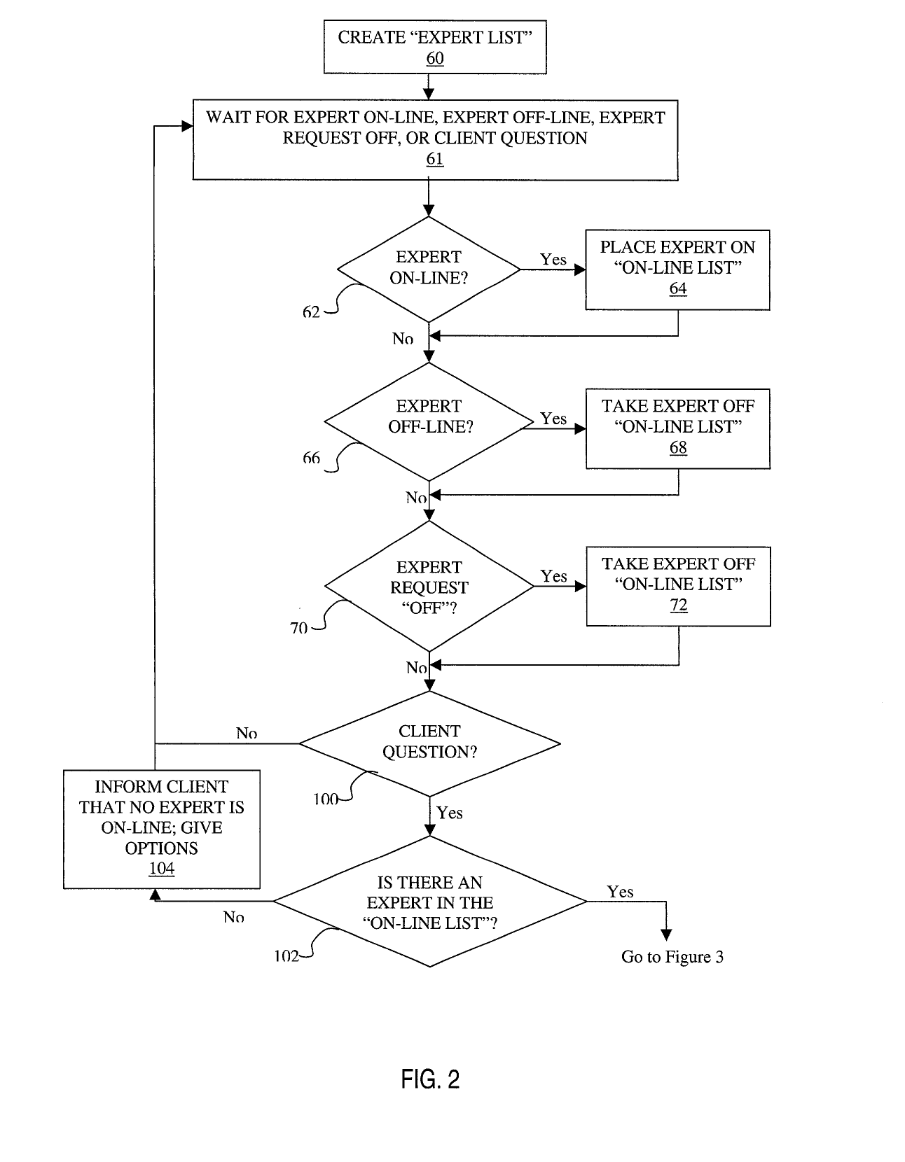

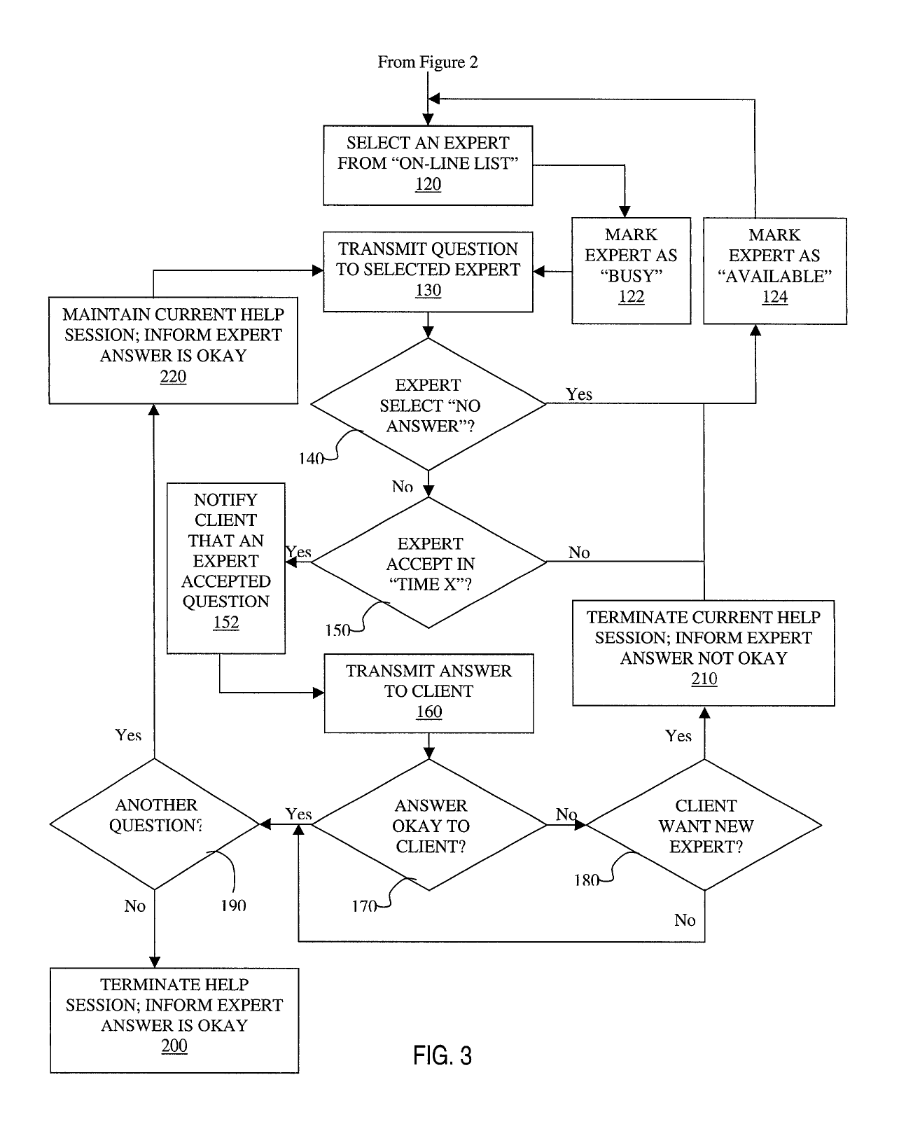

As shown in FIG. 2 of the drawings and specifically block 60, the expert list is created either manually or automatically. The expert list is comprised of at least one individual who is knowledgeable in a particular topic. As shown in block 61 of the drawings, the server computer 20 waits for an expert to go on-line and logon, for an expert to logoff the Internet, for an expert to manually logoff, or for a client's question. There can be certain criteria set for allowing an individual to become an expert upon the expert list such as education, experience, or the amount of time they are on-line.

b. Creating the On-Line List

As shown in test block 62 and block 64, if an expert's computer sends a logon signal to the server computer 20, the identified expert is listed upon the on-line list stored upon the server computer 20. As shown in test blocks 66, 70 and blocks 68, 72, if the expert's computer sends a logoff signal to the server computer 20, the identified expert is removed from the on-line list while still being maintained upon the expert list. If no client question is detect in test block 100, then the server computer 20 continues to loop between block 61 to test block 100 of FIG. 2.

c. Client Submission of Question

As shown in FIG. 2 and test block 100, if a client connected to the Internet accesses a web page recognized by the server computer 20 and types in a question into a “help screen” as shown in FIG. 7. The client then selects the SUBMIT QUESTION button on the help screen to submit the question information to the client server 20 for immediate processing.

d. Selecting an Expert

Upon receipt of the question and client information from the client computer 40, the server computer 20 determines if there is an expert listed within the appropriate on-line list as shown in box 102. As shown in test block 102 and block 104, if there is no expert within the on-line list, the server computer 20 informs the client's computer 40 that there is no expert currently available to answer the question, however the client has the option of “waiting” for an expert to logon and become available. The client could be informed of the total number of experts that are currently upon the on-line list but that they are all unavailable assisting other clients. If no expert is available, another option would be to ask the client if they desire the answer to be sent to their e-mail address when an expert becomes available. The client may also be informed of other websites that may be able to answer the client's question. However, at least one expert generally should be available on-line so as to avoid this issue.

The client may also enter in criteria for the type of expert they want to answer their question based upon the data information in the expert's data file such as age, years experience, education level, geographical location, qualifications, education background and other important criteria. The expert criteria would be selected or entered into the web page shown in FIG. 7 of the drawings. The server computer 20 would then match the criteria entered into the client computer 40 with known criteria of experts on the on-line list. The expert could be selected from the criteria either randomly or in a set order. If using the “set order” method of selecting an expert, the server computer 20 could select expert #1 first every time for each client. However, a more realistic use of the “set order” method of selecting an expert would include selecting expert #1 for the first question, expert #2 for the second question and so fort until all of the experts have had an opportunity to answer a question, at which time the server computer 20 would start again with expert #1 and proceed accordingly. It can be appreciated that additional features such as limiting the number of questions per day each expert can answer could disqualify some experts from the on-line list. The selection of experts is limited only by the imagination of the programmer of the server computer 20.

As shown in box 122 of FIG. 3, when an expert is selected by the server computer 20, the expert is marked as “busy” but still upon the on-line list. Another method would include temporarily removing the selected expert from the on-line list so that the expert does not receive two or more questions submitted simultaneously. Once the expert is finished with answering the question, the expert will be marked as “available” removing the busy marking upon the on-line list as shown in box 124. The alternative method is utilized of removing the expert from the on-line list, then the expert would simply be added back to the on-line list. It can be appreciated that the features shown in boxes 122, 124 could be left out of the present invention with the only potential problem being that an expert could receive more than one question simultaneously or within a small time frame.

As shown in box 130 of FIG. 3, the question and client information is transmitted from the server computer 20 to the expert computer 50 via the Internet 30. Using the help software installed upon the expert computer 50, a dialog box is automatically displayed showing the client name and the question as shown in FIG. 8 of the drawings. It can be appreciated that the dialog box does not have to automatically be displayed to alert the expert that a question is queried upon the expert computer 50. Audio and visual signals may be utilized to alert the expert that a question is upon the expert computer 50 giving them the opportunity to select an icon that displays the dialog box when desired.

e. Accepting or Rejecting the Question

(i) Rejecting the Question

Once the dialog box of FIG. 8 is shown on the expert computer 50, the expert has the option of accepting or rejecting to answer the question within time X based upon whether they feel they are qualified to answer the question and other factors as shown in test box 140. If the expert selects that they do not desire to answer the question, the expert is placed back upon the on-line list as shown in box 124. When the expert selects that they do not desire to answer the question, the expert computer 50 immediately communicates with the server computer 20 that the selected expert will not be answering the question, hence the server computer 20 proceeds to locate a different expert as shown in box 120 to answer the question to avoid any significant delays in answering the question.

(ii) No Acceptance or Rejection by Selected Expert

If the expert does not accept or reject the question within time X, which may be 5 to 20 seconds, the question will be automatically withdrawn from the expert by the server computer 20 and the server computer 20 will select a different expert to answer the question for the client. The selected expert will also be placed back upon the online list. It can be appreciated that time X can be any time that the user selects and should not be limited by any discussions in this application.

There may be another feature of the current program that eliminates the need for an expert to actually “select” whether they accept or reject a certain question. A feature of the help software could include that if the expert begins typing an answer, though not submitted, that an “accept signal” would be automatically sent to the server computer 20. This feature could be utilized alone or in conjunction with the accept/reject feature. If the expert did not submit the written answer within a specified period of time, such as one minute, the server computer 20 could assume that the expert is not going to answer in an desirable time frame and select a different expert to answer the question for the client.

If an expert does not respond within time X to a certain number of questions in a given period of time, it can be assumed that the expert computer 50 is on-line but that the expert is not accessing their computer. Hence, to prevent this expert from receiving further questions that will only delay the process, the server computer 20 may remove the expert from the EOLL for a specified period of time such as one day so as to prevent further delays in questions being answered.

(iii) Accepting the Question

If the expert accepts the question, an accept signal is transmitted to the server computer 20 via the Internet 30. The expert may accept the question by selecting “yes” to accepting the question or by beginning typing of the answer into the answer box.

As shown in box 152 of FIG. 3, the server computer 20 may transmit a signal to the client computer 40 to inform the client that an expert has accepted the question and that an answer will be sent within a few minutes. The server computer 20 may also provide information for the client such as the name of the expert, location of the expert, qualifications and other information for the client to review prior to receiving the answer.

f. Expert Submission of Answer

As shown in FIG. 8 of the drawings, the expert types the answer to the question in a dialog box upon their computer 50. When finished with the answer, the expert selects the SUBMIT ANSWER button on the screen of their computer 50 which causes the expert computer 50 to send the answer information to the server computer via the Internet. It can be appreciated that the answer could be sent to the client computer 40 in “real time” as the expert types the answer, however this is generally not preferable since most experts will want to at least briefly review their answers prior to sending to the client to ensure accuracy and content. It is possible that the answer could be sent via conventional e-mail from the expert to the client to avoid having to utilize a web page to display the answer, after when the answer is sent via e-mail the client is notified that the answer is being sent or is in their mailbox.

Once the server computer 20 receives the answer information from the expert computer 50, the answer is then transmitted to the client computer 40 in a viewable web page as shown in box 160 and in FIG. 9. It can be appreciated that the client computer 40 may have software installed upon their computer to receive the answer information in a format different that what is readable by a conventional web browser.

g. Client Rejection of Answer

The client reviews the answer shown on the client computer 40 and then selects whether the answer is adequate or not as shown in test block 170. The client can also “rank” the answer and the expert if desired based upon various factors such as quality and timeliness. If the answer is not acceptable to the client, the server computer 20 will provide an option for the client to receive another answer from a different expert as shown in test block 180. If the client chooses to have a different expert answer the same question, then the selected expert is notified that the answer was deemed inadequate by the client and that the client has requested a different expert to answer the question as shown in box 210. The selected expert is then added back to the on-line list as shown in box 124 of FIG. 3. If the client states that the answer was inadequate but that they do not want a different expert, the client is given the option of asking the selected expert another question as shown in test block 190.

h. Client Acceptance of Answer

If the client selects that the answer is adequate, the client is given the option of asking the selected expert another question as shown in test block 190 of FIG. 3. It can be appreciated that the client could accept the answer but want a different question from a different expert. If the client selects that they do not want to ask another question, then the help session is terminated as show block 200 with the expert notified that the answer was acceptable but that the client had no further questions. If the client selects that they would like to ask another question from the selected expert, then the client is provided a clean question screen as shown in FIG. 7 to type their new question and the expert is notified that the client found the answer acceptable and would like to ask another question from the expert. The process then continues between the client and the selected expert until the client terminates the help session with the selected expert or the selected expert desires to no longer answer questions from the particular client.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An Internet based help system for providing the exchange of information between a client and an expert via the Internet, said Internet based help system comprising:
means for maintaining an expert list;
means for maintaining an on-line list;
means for logging an expert from said expert list onto said on-line list when the expert is currently available over the Internet;
means for marking an expert as unavailable from said on-line list;
means under selective control of the client to enter a question information and submit the question information;
means for selecting an expert from said on-line list;
means for communicating the question information to a selected expert from said on-line list;
means for displaying the question information upon the selected expert's computer; and
means under selective control of the selected expert to enter answer information and submit the answer information to the client via the Internet.

2. The Internet based help system of claim 1, wherein said means for maintaining an expert list maintains database information about each expert upon said expert list.

3. The Internet based help system of claim 2, wherein said means under selective control of the client allows the client to enter criteria for determining an expert upon said on-line list using said database information.

4. The Internet based help system of claim 1, wherein said means for selecting an expert comprises a predetermined method.

5. The Internet based help system of claim 4, wherein said predetermined method is comprised of selecting an expert from said on-line list at random.

6. The Internet based help system of claim 4, wherein said predetermined method is comprised of selecting an expert from said on-line list in a respective order.

7. The Internet based help system of claim 4, wherein said predetermined method is comprised of selecting an expert based upon criteria entered by the client.

8. The Internet based help system of claim 1, including a means for determining whether an expert upon said expert list is providing adequate answers to the questions of clients and removing the expert from said on-line list if the expert is providing less than Z percentage adequate answers to the clients.

9. The Internet based help system of claim 1, including a means for determining whether an expert upon said expert list is responding within time X to Y percentage of questions and removing the expert from said on-line list if the expert is responding to less than Y percentage of questions within time X.

10. A method of communicating between a client and an expert via the Internet, the method comprising the steps of:
(a) displaying a request page on a client computer;
(b) receiving question information upon said request page from the client;
(c) transmitting said question information to a server computer;
(d) selecting an expert that is currently on-line;
(e) displaying said question information upon a computer of the selected expert;
(f) determining whether the expert of said expert computer desires to respond to said question information;
(g) repeating steps (d) through (f) if the selected expert desires not to respond to said question information;
(h) receiving answer information from the selected expert;
(i) transmitting the answer information to said server computer; and
(j) transmitting the answer information to said client computer for display to the client.

11. The method of claim 10, further comprising the step of determining whether an expert is currently on-line and providing alternative choices to the client if there is no expert on-line.

12. The method of claim 11, wherein one of said alternative choices includes waiting for an expert to become available.

13. The method of claim 10, including the step of marking the selected expert as unavailable.

14. The method of claim 10, including the step of providing the client the opportunity to provide feedback regarding the answer information.

15. A method of communicating between a client and an expert via the Internet, the method comprising the steps of:
(a) providing an expert list;
(b) creating an on-line list based upon the experts from said expert list that are currently on-line;
(c) receiving question information from a client;
(d) selecting an expert from said on-line list and transmitting said question information to the expert;
(e) receiving answer information from the expert and transmitting said answer information to the client.

16. The method of claim 15, wherein said step of selecting an expert is comprised of a predetermined method.

17. The method of claim 15, wherein said step of creating an on-line list includes the step of removing an expert that is no longer on-line.

18. The method of claim 15, including the step of determining whether the selected expert desires to answer the question information and repeating steps (d) and (e) if the selected expert desires not to answer the question information.

19. An Internet based help system for providing the exchange of information between a client computer, a server computer and an expert computer via the Internet, said Internet based help system comprising:
said server computer storing an expert list and an on-line list of experts available;
a question screen displayable upon said client computer for allowing a client to enter question information into;
a means for transmitting said question information to said server computer;
a means for selecting an expert from said on-line list;
a means for notifying said expert that they have been selected to answer a question;
an answer screen displayable upon said expert computer for allowing the selected expert to review said question information and for entering answer information; and
a means for transmitting said answer information to said client computer.

20. The Internet based help system of claim 19, wherein said server computer adds and removes experts from said on-line list based upon logon and logoff information from the expert computers.

21. The Internet based help system of claim 19, wherein said answer screen has an option for allowing the selected expert to pass or accept upon the question information.

22. The Internet based help system of claim 19, wherein if the selected expert does not accept to answer the question information within time period X, the server computer selects a different expert from the on-line list if available.

23. The Internet based help system of claim 22, wherein if there are no other available experts upon the on-list, said server computer waits time period Y prior to providing alternative choices to said client computer.

24. The Internet based help system of claim 19, wherein said server computer removes an expert from said expert list and said on-line list if the expert is not responding in a desirable manner to a minimum number of questions presented to the expert.
